(19) United States
(12) Patent Application Publication
(10) Pub. No.: US 2016/0144380 A1
(43) Pub. Date: May 26, 2016

(54) COMPOSITE DUST COLLECTOR

(71) Applicant: EPiT Co., Ltd., Incheon (KR)

(72) Inventors: Jong Moon KIM, Incheon (KR); Sang Mook SHIN, Incheon (KR); Dong Young KIM, Incheon (KR)

(21) Appl. No.: 14/574,318

(22) Filed: Dec. 17, 2014

(30) Foreign Application Priority Data
Nov. 26, 2014 (KR) 10-2014-0166229

(51) Int. Cl. B03C 3/88; B03C 3/017

(52) U.S. Cl. CPC B03C 3/88; B03C 3/017

(57) ABSTRACT

A composite dust collector includes an electrically collecting field collecting a dust contained a dust gas entering along a gas passage with a dust collecting electrode and a discharging electrode, a mesh filter collecting a fine dust discharged as the dust gas passing through the electrically collecting field flows, and a collected dust remover blowing the fine dust collected in the mesh filter from the outside to the inside to remove.

### RELATED APPLICATIONS

This application is based on and claims priority to Korean Patent Application No. 10-2014-0166229, filed on Nov. 26, 2014, the disclosure of which is incorporated herein in its entirety by reference.

### FIELD OF THE INVENTION

The present invention relates to a dust collector, and more particularly, to a composite dust collector suitable for removing various kinds of dust contained in a dust gas (or a dust fluid) by electrically collecting and filtering.

### BACKGROUND OF THE INVENTION

As widely known, plants generating dust in great quantities, such as a steam power plant, an incineration plant, a cement plant, and the like, essentially uses an electric precipitator or a filter dust collector to cope with atmospheric pollution (environmental pollution).

For example, the electric precipitator removes or purifies dust contained in a dust gas that is introduced through a gas path (for example, a gas introduction duct) by which dust is charged with negative ions by continuous charging of a high voltage charging device using a discharging electrode and a dust collecting plate and is collected.

In this case, the electric precipitator may include a plurality of electrically independent fields, that is, a plurality of electric dust collecting fields. Here, the term “electrically independent” used herein means the situation such that each of the fields is provided with an independent transformer-rectifier so that another fields work even when one field is shorted and out of order.

An existing electric dust collector removes or separates dust to rap a discharging electrode and a dust collecting plate with a rapping device (for example, a hammer strikes a supporting shaft of the dust collecting plate or the discharging electrode at an upper side or a lateral side of the dust collecting plate) such that the collected dust falls down.

However, when the discharging electrode and the dust collecting plate are rapped with the rapping device, relatively large dust (for example, larger than 100 micrometers) falls down well even when a gas is blown, while relatively tiny dust (for example, smaller than 50 micrometers) does not easily fall down but is scattered again as the gas flows.

That is, when it is assumed three fields are built, fine dust not collected in and passing through a first field and a second field or scattered may be collected in the next field. However, since any device does not collect fine dust passing through the final field or scattered again in the next field, the fine dust may be discharged out of a stack through a gas-discharging duct.

### SUMMARY OF THE INVENTION

In view of the above, the present invention provides a composite dust collector capable of collecting dust contained in a dust gas by electrically collecting and filtering.

In accordance with an embodiment of the present invention, there is provided a composite dust collector, which includes an electrically collecting field collecting a dust contained a dust gas entering along a gas passage with a dust collecting electrode and a discharging electrode, a mesh filter collecting a fine dust discharged as the dust gas passing through the electrically collecting field flows, and a collected dust remover blowing the fine dust collected in the mesh filter from the outside to the inside to remove.

In the exemplary embodiment, the mesh filter may be a curved metal wire mesh structure.

In the exemplary embodiment, the mesh filter may be a folder type metal wire mesh structure.

In the exemplary embodiment, the mesh filter may be a rectangular metal wire mesh structure.

In the exemplary embodiment, the mesh filter may be a metal wire mesh structure woven with a metal wire.

In the exemplary embodiment, the mesh filter may be made of a conductor with electric conductivity.

In the exemplary embodiment, the collected dust remover may include a rail fixed to a dust collector body, and a fan and a plenum moving transversely along the rail to blow.

In the exemplary embodiment, the electrically collecting field may include a plurality of electrically collecting field groups that work electrically and independently.

In the exemplary embodiment, the electrically collecting field further may include a rapping system removing the collected dust.

According to the present invention, dust contained in a dust gas is removed in a composite method of electrically collecting and filtering to block fine dust from being scattering again caused by rapping so that atmospheric pollution caused by the re-scattering fine dust can be effectively prevented.

Moreover, a metal wire mesh filter employed in the present invention removes dust in a mechanical filtering and serves as a positive (+) electrode dust collecting plate, so that a great quantity of electrically negative (−) fine dust that is not collected in the previous fields may be stuck to remove. Thus, the composite dust collector according to the present invention is not an added device but may reduce a dust collecting space so that early investment cost may be also reduced.

### BRIEF DESCRIPTION OF THE DRAWINGS

FIG. 1 is a schematic view illustrating a plant system suitable for applying a composite dust collector according to an embodiment of the present invention;

FIG. 2 is a transparent perspective view illustrating an interior of the composite dust collector according to an embodiment of the present invention;

FIG. 3 is a view illustrating an example of a mesh filter applicable to the composite dust collector according to an embodiment of the present invention;

FIG. 4 is a view illustrating another example of the mesh filter applicable to the composite dust collector according to an embodiment of the present invention; and

FIGS. 5A to 5E are views illustrating examples of metal wire meshes applicable to the composite dust collector according to an embodiment of the present invention.

### DETAILED DESCRIPTION OF THE EMBODIMENTS

First, the advantages and features of exemplary embodiments according to the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the scope of the present invention will be defined only by the appended claims.

In the following description, well-known functions or constitutions will not be described in detail if they would unnecessarily obscure the features of the present invention. Further, the terms to be described below are defined in consideration of functions in the present invention and may vary depending on intentions or practices of a user or an operator. Accordingly, the definition may be made on a basis of the content throughout the specification.

Hereinafter, a composite dust collector according to an embodiment of the present invention will be described with reference to the accompanying drawings.

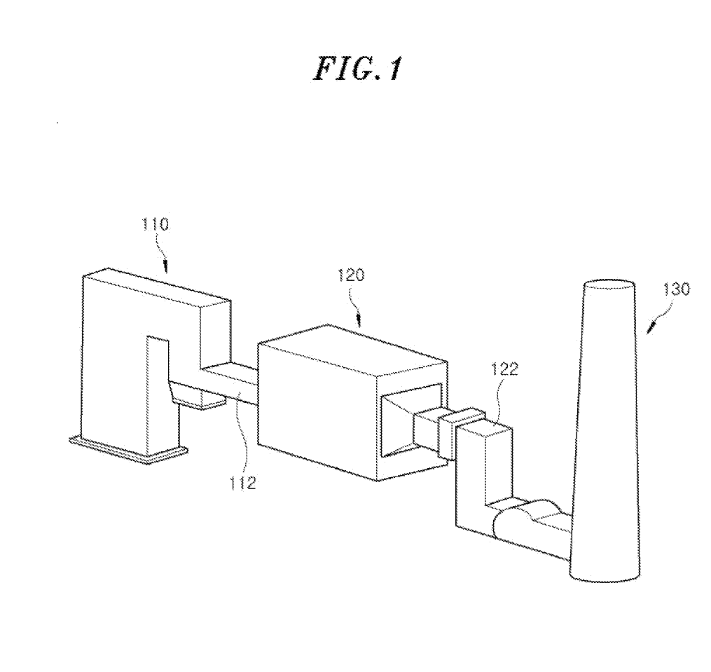

FIG. 1 is a schematic view illustrating a plant system suitable for applying a composite dust collector according to an embodiment of the present invention.

With reference to FIG. 1, a dust collector 120 is disposed between a main production apparatus of a plant 110 and a stack 130 and may collect raw material scattered during the production such as dust from a boiler, cement, and the like.

First, the plant 110 may be a boiler and a dust gas containing dust generated due to heat when the boiler is running is transferred to a dust collector 120 through in inlet duct 112. The inlet duct 112 may be defined as a gas passage.

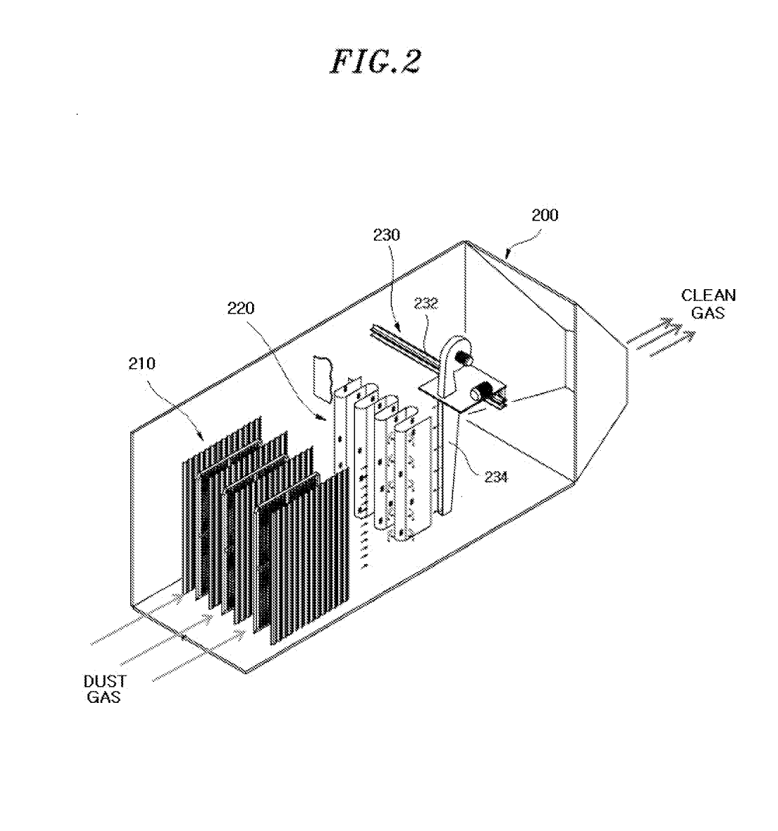

Next, the dust collector 120 means a composite dust collector according to an embodiment of the present invention, removes or purifies dust contained in the dust gas (or a dust fluid) entering through the inlet duct 112, and discharges a clean gas from which the dust is removed to the stack 130 through an outlet duct 122. To this end, the dust collector 120 may be configured as shown in FIG. 2.

FIG. 2 is a transparent perspective view illustrating an interior of the composite dust collector according to the embodiment of the present invention. The dust collector 120 may include an electrically collecting field 210, a mesh filter 220, and a collected dust remover 230.

Referring to FIG. 2, a dust collector body 200 is provided with an electrically collecting field 210 collecting dust contained in the dust gas entering the inlet duct (or a gas passage) using a dust collecting electrode and a discharging electrode. The electric collecting field 210 may include a plurality of electrically collecting field groups (for example, two to eight electrically collecting field groups) electrically and independently working.

The term “electrically independence” used herein may mean that each of the fields includes an independent transformer-rectifier such that another electrically collecting field groups may work even when a single electrically collecting group is shorted and out of order.

Although omitted in FIG. 2, the electrically collecting field 210 is installed with a rapping system rapping the discharging electrode and the dust collecting plate (for example, a hammer strikes a supporting shaft of a dust collecting plate or a the discharging electrode at an upper or lateral side of the dust collecting plate) to drop down (remove) the collected dust.

When the rapping system strikes the discharging electrode and the dust collecting plate, a relative large dust (for example, greater than 50 micrometers) falls down, while a relatively small (weakly crumpled) fine dust (for example, less than 50 micrometers) does not fall down but may be scattered again as a gas flows.

The re-scattering of the fine dust may be generated at start-up of the plant, at replacement of fuel of the plant, by the change of a sudden change in the plant (such as quantity of gas, temperature, etc.), during the blowing process of instant increase of quantity of a gas to remove soot generated from the plant.

In this case, the fine dust discharged from the electrically collecting field 210 to the mesh filter 220 may contain a fine dust that is relatively fine so that the fine dust does not stick to the dust collecting plate in the electrically collecting field 210 but is scattered (that is, a fine dust is charged, but not attracted to the dust collecting plate, is scattered as a gas flows and not collected and then discharged), a fine dust scattered again when the electrically collecting field 210 removing (or separating) the collected dust is rapped, and a fine dust having a low resistance and losing an electrically negative (−) charge soon to an electrically positive (+) dust collecting plate (that is, is discharged) and scattered again even when the fine dust sticks to the dust collecting plate.

Next, the mesh filter 220 may provide a function of collecting (or removing) a fine dust (for example, a fine dust less than 50 micrometers) discharged as a gas flows from the electrically collecting field 210. That is, the mesh filter 220 removes the dust in a mechanical filtering and also serves as an electrically positive (+) dust collecting plate to attach and remove a great quantity of the electrically negative (−) fine dust that is not collected in the electrically collecting field 210.

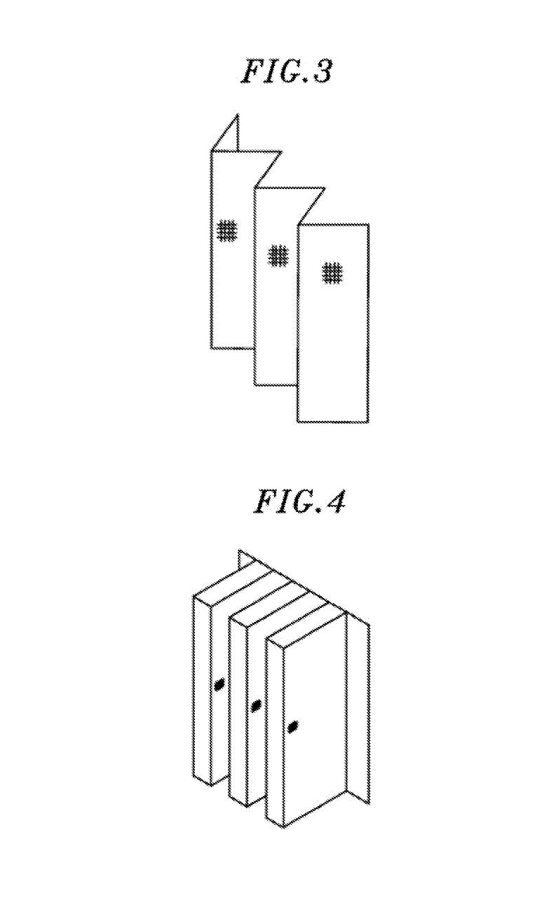

To this end, the mesh filter 220 may include a curved metal wire mesh structure as illustrated in FIG. 2, a folder type metal wire mesh structure as illustrated in FIG. 3, or a rectangular metal wire mesh structure as illustrated in FIG. 4. In this case, the reason why the mesh filter 220 is made of a main element, that is, a metal (metal material) is to serve as a dust collecting plate (electrically positive electrode).

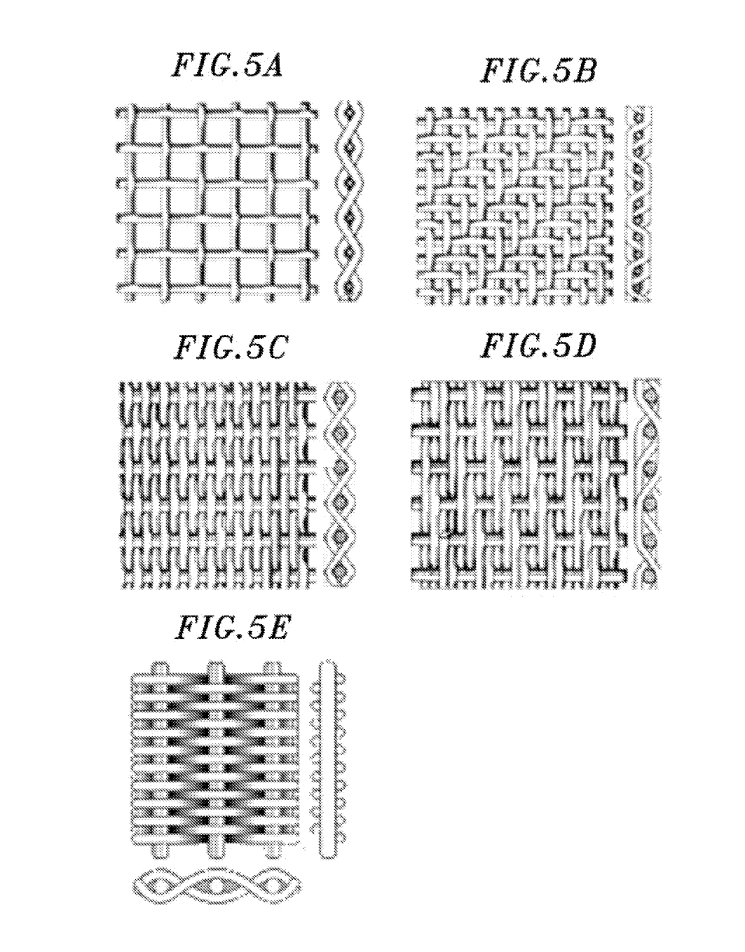

In addition, the mesh filter 220, as illustrated in FIGS. 5A to 5E, may include various metal wire mesh structures woven with metal wires. Respective holes in the metal wire mesh, according to the condition where the electrically dust collector of the present invention is applied, may be less than 100 micrometers or greater than 100 micrometers.

Moreover, the mesh filter 220 may be made of not a metal, but a material with relatively high electric conductivity, such as a conductor made of a mixture of carbon fiber and metal fiber.

Alternatively, the mesh filter 220 may be a porous plate having a plurality of small holes (small apertures) formed in metal plate.

Specifically, the composite dust collector according to the present invention is installed with the mesh filter 220 at a rear end (or a final end) of the dust collector body 200 collects a fine dust that is relatively fine so that the fine dust does not stick to the dust collecting plate in the electrically collecting field but is scattered, a fine dust scattered again when the electrically collecting field is rapped, and a fine dust having a low resistance and losing an electrically negative (−) charge soon to an electrically positive (+) dust collecting plate (that is, is discharged) and scattered again even when the fine dust sticks to the dust collecting plate, so that it is possible to block (prevent) the fine dust from being discharged out to the stack 130 via the outlet duct 122.

The collected dust remover 230 may be mounted at a rear side of the mesh filter 220 and may provide a function of blowing a fine dust collected in the mesh filter 220 during a periodic running by a driving source such as a motor (not shown) from the outside (that is, a side opposite to a position where the electrically collecting field is positioned) to an inside (a side where the electrically collecting field is positioned) to remove (drop down) the fine dust. Here, the blowing may achieve removal of a fine dust such that blocking of meshes and pressure loss in the mesh filter can be minimized.

To this end, the collected dust remover 230 may include a rail 232 fixed to the dust collector body 200 and a fan and a plenum 234 moving transversely to blow along the rail 232. The fan providing a driving power to transfer the gas from which dust is removed toward the stack 130 may be separately fixed while the plenum may move transversely.

The explanation as set forth above is merely described a technical idea of the exemplary embodiments of the present invention, and it will be understood by those skilled in the art to which this invention belongs that various changes and modifications may be made without departing from the scope of the essential characteristics of the embodiments of the present invention. Therefore, the exemplary embodiments disclosed herein are not used to limit the technical idea of the present invention, but to explain the present invention, and the scope of the technical idea of the present invention is not limited to these embodiments.

Therefore, the scope of protection of the present invention should be construed as defined in the following claims and changes, modifications and equivalents that fall within the technical idea of the present invention are intended to be embraced by the scope of the claims of the present invention.

What is claimed is:

1. A composite dust collector comprising:
an electrically collecting field collecting a dust contained a dust gas entering along a gas passage with a dust collecting electrode and a discharging electrode;
a mesh filter collecting a fine dust discharged as the dust gas passing through the electrically collecting field flows; and
a collected dust remover blowing the fine dust collected in the mesh filter from the outside to the inside to remove.

2. The composite dust collector of claim 1, wherein the mesh filter comprises a curved metal wire mesh structure.

3. The composite dust collector of claim 1, wherein the mesh filter comprises a folder type metal wire mesh structure.

4. The composite dust collector of claim 1, wherein the mesh filter comprises a rectangular metal wire mesh structure.

5. The composite dust collector of claim 1, wherein the mesh filter comprises a metal wire mesh structure woven with a metal wire.

6. The composite dust collector of claim 1, wherein the mesh filter is made of a conductor with electric conductivity.

7. The composite dust collector of claim 1, wherein the collected dust remover comprises:
a rail fixed to a dust collector body; and
a fan and a plenum moving transversely along the rail to blow.

8. The composite dust collector of claim 1, wherein the electrically collecting field comprises a plurality of electrically collecting field groups that work electrically and independently.

9. The composite dust collector of claim 1, wherein the electrically collecting field further comprises a rapping system removing the collected dust.
